(19) United States
(12) Patent Application Publication
(10) Pub. No.: US 2016/0049809 A1
(43) Pub. Date: Feb. 18, 2016

(54) STORAGE BATTERY AND OPERATION METHOD OF STORAGE BATTERY

(71) Applicant: NEC CORPORATION, Tokyo (JP)

(72) Inventors: Hiroshi KAJITANI, Tokyo (JP); Koji MATSUNAGA, Tokyo (JP); Katsuya ONOSE, Tokyo (JP)

(21) Appl. No.: 14/780,119

(22) PCT Filed: Mar. 7, 2014
(86) PCT No.: PCT/JP2014/055985

§ 371 Date: Sep. 25, 2015

(30) Foreign Application Priority Data
Mar. 28, 2013 (JP) 2013-069161

(51) Int. Cl. H02J 7/00

(52) U.S. Cl. CPC H02J 7/0014

(57) ABSTRACT

A storage battery includes an electricity storage unit (10) including a first battery cell group in which a plurality of first battery cells (10-1, and the like) are connected in series, an auxiliary electricity storage unit (11) including a second battery cell group in which a plurality of second battery cells (11-1, and the like) capable of performing higher-speed charging and discharging in comparison to the first battery cells (10-1, and the like) are connected in series, a voltage adjustment unit (14) that performs voltage adjustment during power delivery between the electricity storage unit (10) and the auxiliary electricity storage unit (11), a first switching unit (12) which is capable of individually connecting the plurality of first battery cells (10-1, and the like) to the voltage adjustment unit (14), and which is capable of connecting the first battery cells to the voltage adjustment unit (14) in an individual combination unit of two or more of the first battery cells (10-1, and the like), and a second switching unit (13) which is capable of individually connecting the plurality of second battery cells (11-1, and the like) to the voltage adjustment unit (14) and which is capable of connecting the second battery cells (11-1, and the like) to the voltage adjustment unit (14) in an individual combination unit of two or more of the second battery cells (11-1).

### TECHNICAL FIELD

The present invention relates a storage battery and an operation method of the storage battery.

### BACKGROUND ART

An invention related to the invention is disclosed in Patent Document 1 and Patent Document 2.

Patent Document 1 discloses a storage battery in which at least one secondary battery and at least one capacitor are connected in parallel.

Patent Document 2 discloses a power supply device including a plurality of batteries which are connected in series, an equalization circuit which detects a residual capacity of each of the batteries to detect an excessive-capacity battery in which the residual capacity is greater than a set value, and connects the battery determined as the excessive-capacity battery to a capacitor or a preliminary battery to make the residual capacity of the excessive-capacity battery small for balance in the residual capacity of the battery, and a power supply circuit that supplies power charged in the capacitor or the preliminary battery to a load. The power supply device charges the capacitor or the preliminary battery using the excessive-capacity battery, and supplies power from the capacitor or the preliminary battery to the load, thereby making the residual capacity of the respective batteries uniform.

### RELATED DOCUMENT

### Patent Document

[Patent Document 1] Japanese Unexamined Patent Publication No. 2004-15866
[Patent Document 2] Japanese Unexamined Patent Publication No. 2007-14148

### DISCLOSURE OF THE INVENTION

In the storage battery in which a plurality of battery cells are connected in series, it is necessary to perform balance processing at a predetermined timing so as to make a difference in an amount of charged power (an amount of power that is charged at the point of time) between battery cells small. The balance processing is classified into a passive cell balance type and an active cell balance type. In the passive cell balance type, a battery cell, which has an amount of charged power which is greater than that of other battery cells, is connected to a discharging resistor and is discharged, thereby making the difference in the amount of charged power small. In the active cell balance type, power is supplied from a battery cell in which the amount of charged power is greater than that of other battery cells to a battery cell in which the amount of charged power is less than that of other battery cell by using a capacitor, an inductor, a transformer, and the like, thereby making the difference in the amount of charged power small.

However, in a storage battery in which an electricity storage unit configured as follows and a storage battery configured as follows are connected in parallel, providing a balance circuit for both the electricity storage unit and the auxiliary electricity storage unit can be considered. In the electricity storage unit, a plurality of battery cells (for example, lithium ion secondary batteries (LIB), and the like), which are less capable of performing high-speed charging and discharging (high-rate charging and discharging) in comparison to a battery cell such as a capacitor capable of performing the high-speed charging and discharging, are connected in series. In the auxiliary electricity storage unit, a plurality of battery cells (for example, capacitors and the like), which are capable of performing the high-speed charging and discharging, are connected in series. According to the configuration, it is possible to simultaneously perform balance processing with respect to the electricity storage unit and balance processing with respect to the auxiliary electricity storage unit, and thus the configuration is efficient. However, in the case of providing a plurality of the balance circuits, there is a problem in that the cost increases in addition to the necessity of many installation spaces for the balance circuits.

An object of the invention is to provide a new balance processing technology in a storage battery in which an electricity storage unit and an auxiliary electricity storage unit are connected in parallel, the electricity storage unit including a plurality of battery cells which are not capable of performing high-speed charging and discharging and are connected in series, and the auxiliary electricity storage unit including a plurality of battery cells which are capable of performing the high-speed charging and discharging and are connected in series.

According to an aspect of the invention, there is provided a storage battery including: an electricity storage unit including a first electricity storage unit group in which a plurality of first electricity storage units are connected in series; an auxiliary electricity storage unit which includes a second electricity storage unit group in which a plurality of second electricity storage units capable of performing higher-speed charging and discharging in comparison to the first electricity storage units are connected in series, and performs power delivery with the electricity storage unit; a voltage adjustment unit that performs voltage adjustment during the power delivery between the electricity storage unit and the auxiliary electricity storage unit; a first switching unit which is capable of individually connecting the plurality of first electricity storage units included in the first electricity storage unit group to the voltage adjustment unit, and which is capable of connecting the first electricity storage units to the voltage adjustment unit in an individual combination unit of two or more of the first electricity storage units; and a second switching unit which is capable of individually connecting the plurality of second electricity storage units included in the second electricity storage unit group to the voltage adjustment unit, and which is capable of connecting the second electricity storage units to the voltage adjustment unit in an individual combination unit of two or more of the second electricity storage units.

In addition, according to another aspect of the invention, there is provided an operation method of a storage battery. The storage battery includes: an electricity storage unit including a first electricity storage unit group in which a plurality of first electricity storage units are connected in series; an auxiliary electricity storage unit which includes a second electricity storage unit group in which a plurality of second electricity storage units capable of performing higher-speed charging and discharging in comparison to the first electricity storage units are connected in series; a voltage adjustment unit; a first switching unit which is capable of individually connecting the plurality of first electricity storage units included in the first electricity storage unit group to the voltage adjustment unit, and which is capable of connecting the first electricity storage units to the voltage adjustment unit in an individual combination unit of two or more of the first electricity storage units; and a second switching unit which is capable of individually connecting the plurality of second electricity storage units included in the second electricity storage unit group to the voltage adjustment unit, and which is capable of connecting the second electricity storage units to the voltage adjustment unit in an individual combination unit of two or more of the second electricity storage units. A difference in an amount of charged power between the plurality of first electricity storage units included in the first electricity storage unit group is made to be small, and a difference in an amount of charged power between the plurality of second electricity storage units included in the second electricity storage unit group is made to be small through a process of supplying power from one or the plurality of first electricity storage units to one or the plurality of second electricity storage units through the voltage adjustment unit, and a process of supplying power from one or the plurality of second electricity storage units to one or the plurality of first electricity storage units through the voltage adjustment unit.

According to the invention, it is possible to realize a new balance processing technology in a storage battery in which an electricity storage unit and an auxiliary electricity storage unit are connected in parallel, the electricity storage unit including a plurality of battery cells which are not capable of performing high-speed charging and discharging and are connected in series, and the auxiliary electricity storage unit including a plurality of battery cells which are capable of performing the high-speed charging and discharging and are connected in series.

### BRIEF DESCRIPTION OF THE DRAWINGS

The above and other objects, advantages and features of the present invention will become more apparent from the following description of certain preferred embodiments taken in conjunction with the accompanying drawings.

FIG. 1 is an example of a functional block diagram of a storage battery of this embodiment.

FIG. 2 is a flowchart illustrating an example of a processing flow during charging of the storage battery of this embodiment.

FIG. 3 is a flowchart illustrating an example of a processing flow during charging of the storage battery of this embodiment.

FIG. 4 is a flowchart illustrating an example of a processing flow during discharging of the storage battery of this embodiment.

FIG. 5 is a flowchart illustrating an example of a processing flow during discharging of the storage battery of this embodiment.

### DESCRIPTION OF EMBODIMENTS

Hereinafter, an embodiment of the invention will be described with reference to the accompanying drawings. In addition, a common reference numeral will be given to a constituent element that is commonly illustrated in a plurality of drawings, and description thereof will not be repeated.

In addition, a storage battery of this embodiment is realized by a CPU of an arbitrary computer, a memory, a program (also including a program that is downloaded from a storage medium such as a CD and a server on the Internet in addition to a program that is stored in advance in the memory from the shipment of the device) that is loaded on the memory, a storage unit such as a hard disk that stores the program, and an arbitrary combination of hardware and software with focus given to an interface for network connection. In addition, it should be understood by those skilled in the art that various modification examples may be present in a method and a device which realizes the storage battery.

In addition, a functional block diagram that is used in the following description of this embodiment illustrates a functional unit block and not a hardware unit configuration. In this drawing, it is described that each unit is realized as one apparatus, but the realizing means thereof is not limited thereto. That is, the realizing means may have a physically divided configuration or a logically divided configuration.

The storage battery of this embodiment includes an electricity storage unit, an auxiliary electricity storage unit, a voltage adjustment unit, a first switching unit, and a second switching unit. In addition, the storage battery may further include a balance processing unit, and a charging and discharging controller.

The electricity storage unit includes a first battery cell group (first electricity storage unit group) in which a plurality of first battery cells (first electricity storage units) are connected in series. The auxiliary electricity storage unit includes a second battery cell group (second electricity storage unit group) in which a plurality of second battery cells (second electricity storage units) capable of performing higher-speed charging and discharging in comparison to the first battery cells are connected in series, and can perform power delivery to and from the electricity storage units. The voltage adjustment unit performs voltage adjustment during power delivery between the electricity storage unit and the auxiliary electricity storage unit. The first switching unit can individually connect the plurality of first battery cells included in the first battery cell group to the voltage adjustment unit, and can individually perform the connection to the voltage adjustment unit in a combination unit of two or more first battery cells (for example, a combination unit of two or more adjacent first battery cells). The second switching unit can individually connect the plurality of second battery cells included in the second battery cell group to the voltage adjustment unit, and can individually perform the connection to the voltage adjustment unit in a combination unit of two or more second battery cells (for example, in a combination unit of two or more adjacent second battery cells). The balance processing unit can perform a process of supplying power from one or the plurality of the first battery cells to one or the plurality of second battery cells through the voltage adjustment unit, and a process of supplying power from one or the plurality of second battery cells to one or the plurality of first battery cell through the voltage adjustment unit. The charging and discharging controller controls charging and discharging of the electricity storage unit and the auxiliary electricity storage unit.

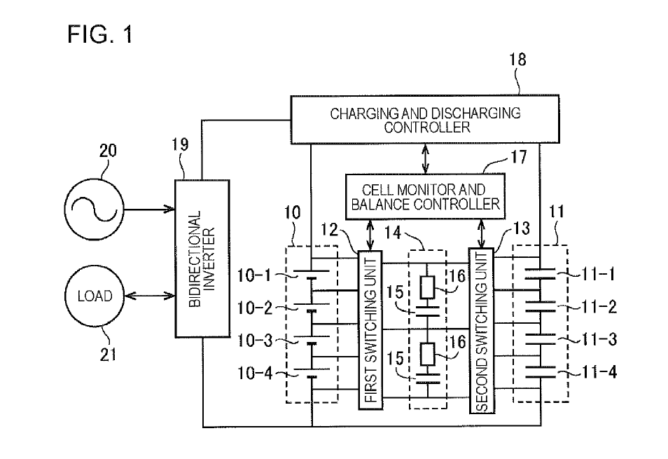

FIG. 1 illustrates an example of a functional block diagram of the storage battery of this embodiment. First, a configuration of the storage battery will be described with reference to the drawing.

The storage battery that is illustrated includes an electricity storage unit 10, an auxiliary electricity storage unit 11, a first switching unit 12, a second switching unit 13, a voltage adjustment unit 14, a cell monitor and balance controller (balance processing unit) 17, a charging and discharging controller 18, and a bidirectional inverter 19. The storage battery is connected to an external power supply 20 or a load (for example, a motor) 21 to perform charging and discharging of power through the bidirectional inverter 19. A configuration of the bidirectional inverter 19 can be realized in accordance with the related art.

The electricity storage unit 10 includes a first battery cell group in which a plurality of first battery cells 10-M are connected in series. In FIG. 1, the first battery cell group, in which four first battery cells 10-1 to 10-4 are connected in series, is illustrated. Each of the first battery cells 10-M can be configured by a lithium ion secondary battery (LIB) cell, a lead storage battery cell, or the like which is capable of realizing high capacity at relatively low cost. In addition, the number of the first battery cells 10-M, which are included in the first battery cell group, is a matter of design, and the four shown in the drawing are illustrative only. The electricity storage unit 10 may include a plurality of the first battery cell groups. For example, the plurality of first battery cell groups are connected in parallel.

The auxiliary electricity storage unit 11 includes a second battery cell group in which a plurality of second battery cells 11-N capable of performing higher-speed charging and discharging in comparison to the first battery cells 10-M are connected in series. In FIG. 1, the second battery cell group, in which four second battery cells 11-1 to 11-4 are connected in series, is illustrated. Each of the secondary battery cells 11-N can be configured by a capacitor cell such as a lithium ion capacitor (LIC) and an electrical double layer capacitor (EDLC), a lithium ion secondary battery (LIB) cell for a hybrid electric vehicle (HEV), or the like. The battery cell can perform higher-speed charging and discharging in comparison to a lithium ion secondary battery (LIB) cell or a lead storage battery cell. In addition, the number of the second battery cells 11-N included in the second battery cell group is a matter of design, and the four shown in the drawing are illustrative only. The number of the first battery cells 10-M included in the first battery cell group and the number of the second battery cells 11-N included in the second battery cell group may be the same as each other or may be different from each other. In addition, the auxiliary electricity storage unit 11 may include a plurality of the second battery cell groups. For example, the plurality of second battery cell groups are connected in parallel. The first battery cell group and the second battery cell group are also connected in parallel.

The voltage adjustment unit 14 performs voltage adjustment to realize power delivery between the electricity storage unit 10 and the auxiliary electricity storage unit 11. The voltage adjustment unit 14 that is illustrated includes a capacitor 15, and a limiting resistor 16. The limiting resistor 16 may be a variable resistor. In addition, an inductor, a transformer, a DC/DC converter, and the like may be employed instead of the capacitor 15.

For example, the first switching unit 12 may be configured of a load switch. The first switching unit 12 can individually connect the plurality of first battery cells 10-M included in the first battery cell group to the voltage adjustment unit 14. In addition, the first switching unit 12 can individually connect the plurality of first battery cells 10-M included in the first battery cell group to the voltage adjustment unit 14 in a combination unit of two or more first battery cells 10-M.

For example, the first switching unit 12 can perform the connection in such a manner that only the first battery cell 10-1 is allowed to be connected to the voltage adjustment unit 14, and the remaining first battery cells 10-2 to 10-4 are not allowed to be connected to the voltage adjustment unit 14. In addition, the first switching unit 12 can perform the connection in such a manner that only the first battery cells 10-1 and 10-2 are allowed to be connected to the voltage adjustment unit 14, and the remaining first battery cells 10-3 and 10-4 are not allowed to be connected to the voltage adjustment unit 14. In addition, the first switching unit 12 can connect all of the first battery cells 10-1 to 10-4 to the voltage adjustment unit 14. The circuit configuration of the first switching unit 12 is a matter of design.

For example, the second switching unit 13 may be configured of a load switch. The second switching unit 13 can individually connect the plurality of second battery cells 11-N included in the second battery cell group to the voltage adjustment unit 14. In addition, the second switching unit 13 can individually connect the plurality of second battery cells 11-N included in the second battery cell group to the voltage adjustment unit 14 in a combination unit of two or more second battery cells 11-N.

For example, the second switching unit 13 can perform the connection in such a manner that only the second battery cell 11-1 is allowed to be connected to the voltage adjustment unit 14, and the remaining second battery cells 11-2 to 11-4 are not allowed to be connected to the voltage adjustment unit 14. In addition, the second switching unit 13 can perform the connection in such a manner that only the secondary battery cells 11-1 and 11-2 are allowed to be connected to the voltage adjustment unit 14, and the remaining second battery cells 11-3 and 11-4 are not allowed to be connected to the voltage adjustment unit 14. In addition, the second switching unit 13 can connect all of the second battery cells 11-1 to 11-4 to the voltage adjustment unit 14. The circuit configuration of the second switching unit 13 is a matter of design.

In addition, the first switching unit 12 and the second switching unit 13 can connect one or the plurality of first battery cells 10-M, and one or the plurality of second battery cells 11-N to the voltage adjustment unit 14.

According to the storage battery of this embodiment which has the above-described configuration, the following balance processing which is performed by the cell monitor and balance controller 17 is realized.

The cell monitor and balance controller 17 is configured to monitor (recognize) an amount of charged power of each of the plurality of first battery cells 10-M, and an amount of charged power of each of the plurality of second battery cells 11-N. The amount of charged power represents an amount of power that is charged in each cell at that point of time, that is, an amount of power that remains in each cell at that point of time (the same shall apply hereinafter). In addition, the cell monitor and balance controller 17 performs balance processing of making a difference in an amount of charged power between the plurality of first battery cells 10-M included in the first battery cell group smaller at a predetermined timing. In addition, the cell monitor and balance controller 17 performs balance processing of making a difference in an amount of charged power between the plurality of second battery cells 11-N included in the second battery cell group smaller at a predetermined timing. As means for monitoring (recognizing) the amount of charged power of each of the plurality of first battery cells 10-M and the amount of charged power of each of the plurality of second battery cells 11-N, the cell monitor and balance controller 17 can employ any technology in the related art without particular limitation thereon.

The cell monitor and balance controller 17 performs a process of supplying power from one or the plurality of first battery cells 10-M to one or the plurality of second battery cells 11-N through the voltage adjustment unit 14, and a process of supplying power from the one or the plurality of second battery cells 11-N to one or the plurality of first battery cells 10-M through the voltage adjustment unit 14, thereby performing the balance processing with respect to the first battery cell group and/or the balance processing with respect to the second battery cell group. Hereinafter, an example of the balance processing performed by the cell monitor and balance controller 17 will be described in detail and is classified into during charging and during discharging.

### Charging Example 1

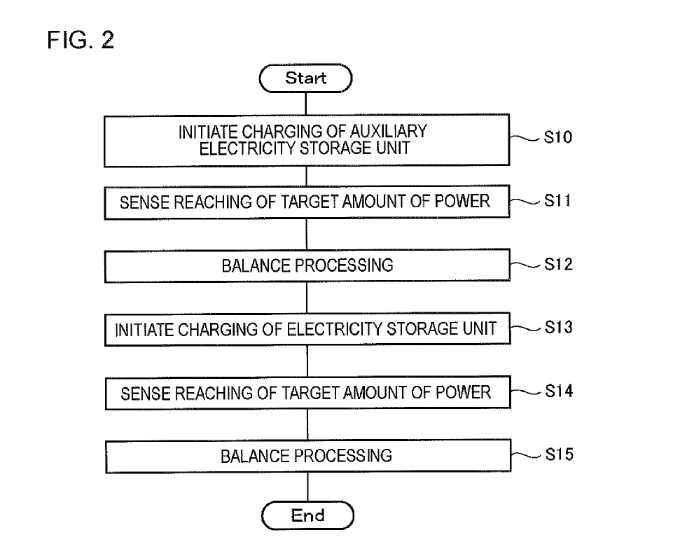

FIG. 2 is a flowchart illustrating an example of a process flow during charging.

When sensing connection of the external power supply 20, the storage battery initiates charging. In addition, before initiation of the charging, the cell monitor and balance controller 17 may detect an amount of charged power of the electricity storage unit 10, the auxiliary electricity storage unit 11, each of the first battery cells 10-M, and each of the second battery cells 11-N. In addition, in an over-discharged state or an over-charged state, the charging may be initiated after performing abnormality processing (minute charging or minute discharging). On the other hand, if the state is not in the over-discharged state or the over-charged state, the charging may be initiated as is.

In the example, first, charging of the electricity storage unit 10 is not performed, and charging of only the auxiliary electricity storage unit 11 is performed (S10).

The charging is realized by control of the charging and discharging controller 18. The cell monitor and balance controller 17 monitors the amount of charged power of each of the plurality of the second battery cells 11-N during the charging process. In addition, when sensing that the amount of charged power reaches a target amount of power (for example, a state in which at least one of the secondary battery cells 11-N reaches a predetermined SOC (state of charge) level, a state in which all of the second battery cells 11-N reach the predetermined SOC level, and the like) (S11), the cell monitor and balance controller 17 makes an input indicating this state to the charging and discharging controller 18. In this case, the charging and discharging controller 18 stops charging the auxiliary electricity storage unit 11. Then, the cell monitor and balance controller 17 performs balance processing with respect to the auxiliary electricity storage unit 11 (S12). The balance processing can be realized by one of the following first to fifth processing examples, or in combination of two or more thereof.

As a first processing example, in a case where the voltage adjustment unit 14 includes the capacitor 15, the inductor, or the transformer, the cell monitor and balance controller 17 can make a difference in the amount of charged power between the plurality of secondary battery cells 11-N small by performing power delivery between the plurality of second battery cells 11-N included in the second battery cell group by using the above-described elements. Specifically, the cell monitor and balance controller 17 supplies power from the second battery cell 11-N in which the amount of charged power is greater than that in the remaining secondary battery cells 11-N to the second battery cell 11-N in which the amount of charged power is less than that in the remaining secondary battery cells 11-N.

As a second processing example, the cell monitor and balance controller 17 can make a difference in the amount of charged power between the plurality of second battery cells 11-N included in the second battery cell group small by supplying power from the secondary battery cell 11-N, in which the amount of charged power is greater than that in the remaining second battery cells 11-N among the plurality of second battery cells 11-N included in the second battery cell group, to the first battery cells 10-M.

As a third processing example, the cell monitor and balance controller 17 can make a difference in the amount of charged power between the plurality of second battery cells 11-N included in the second battery cell group small by supplying power from the secondary battery cell 11-N, in which the amount of charged power is greater than that in the remaining second battery cells 11-N among the plurality of second battery cells 11-N included in the second battery cell group, to the first battery cell 10-M in which the amount of charged power is less than that in the remaining first battery cells 10-M among the plurality of first battery cells 10-M included in the first battery cell group. In the case of this example, it is also possible to make a difference in the amount of charged power between the plurality of first battery cells 10-M included in the first battery cell group smaller to a certain extent.

As a fourth processing example, the cell monitor and balance controller 17 can make a difference in the amount of charged power between the plurality of second battery cells 11-N included in the second battery cell group small by supplying power from the first battery cells 10-M to the second battery cell 11-N in which the amount of charged power is less than that in the remaining second battery cells 11-N among the plurality of second battery cells 11-N included in the second battery cell group.

As a fifth processing example, the cell monitor and balance controller 17 can make a difference in the amount of charged power between the plurality of second battery cells 11-N included in the second battery cell group small by supplying power from the first battery cell 10-M in which the amount of charged power is greater than that in the remaining first battery cells 10-M among the plurality of first battery cells 10-M included in the first battery cell group to the second battery cell 11-N in which the amount of charged power is less than that in the remaining second battery cells 11-N among the plurality of second battery cells 11-N included in the second battery cell group. In the case of this example, it is also possible to make a difference in the amount of charged power between the plurality of first battery cells 10-M included in the first battery cell group small to a certain extent.

In addition, in the case of the second to fifth processing examples, a situation, in which a voltage on a power reception side becomes greater than a voltage on a power supply side, may occur. In this case, power supply may not be realized. This embodiment solves the problem by using the voltage adjustment unit 14. For example, in a case where the voltage adjustment unit 14 includes a DC/DC converter, it is possible to realize the power supply by performing voltage-raising and voltage-lowering with the DC/DC converter. In general, the voltage of one of the first battery cells 10-M becomes higher than the voltage of one of the secondary battery cells 11-N.

In addition, in a case where the voltage adjustment unit 14 does not include the DC/DC converter, it is possible to realize power supply by supplying power from a plurality of battery cells (the first battery cells 10-M or the second battery cells 11-N) which are connected in series to a smaller number of battery cells (the second battery cells 11-N or the first battery cells 10-M) in order for a voltage on a power supply side to be greater than a voltage on a power reception side. For example, power may be supplied from two second battery cells 11-1 and 11-2 which are connected in series to one first battery cell 10-1. In addition, power may be supplied from three first battery cells 10-2 to 10-4 which are connected in series to four second battery cells 11-1 to 11-4 which are connected in series. In addition, in this case, a voltage on a power supply side may be excessively greater than a voltage on a power reception side, and thus a burden may be placed on the power reception side. Accordingly, in this embodiment, power delivery is performed through the voltage adjustment unit 14 including the capacitor 15 (or an inductor or a transformer) and the limiting resistor 16 to reduce the burden. That is, a voltage is appropriately lowered by the limiting resistor 16.

According to the balance processing, it is possible to make a difference in an amount of charged power between the plurality of second battery cells 11-N included in the second battery cell group smaller than a predetermined amount (designed value) without discharging the charged power.

In addition, it is not necessary to perform the balance processing with respect to the second battery cell group only with any one of the first to fifth processing examples, and balance processing (passive cell balance type) of discharging power may be used in combination. Even in this case, it is possible to further reduce an amount of discharge in comparison to a case of performing the balance processing with respect to the second battery cell group only with the passive cell balance type.

In addition, it is not necessary to perform the power delivery between the electricity storage unit 10 and the auxiliary electricity storage unit 11 through the voltage adjustment unit 14 in all cases, and the power delivery may be directly performed between the electricity storage unit 10 and the auxiliary electricity storage unit 11 in some cases.

In addition, as the balance processing in combination of the first to fifth processing examples, the following configuration may be considered. First, power is supplied from the auxiliary electricity storage unit 11 to the electricity storage unit 10 by using the second or third processing example so as to make a difference in the amount of charged power between the plurality of second battery cells 11-N included in the second battery cell group small. In addition, it is assumed that the voltage adjustment unit 14 does not include the DC/DC converter. According to this, power supply from the auxiliary electricity storage unit 11 to the electricity storage unit 10 is performed in a unit of the plurality of second battery cells 11-N which are connected in series (it is assumed that a voltage of one of the first battery cells 10-M is higher than a voltage of one of the second battery cells 11-N). That is, power supply is performed from two or three of the second battery cells 11-N, which are connected in series, to one or two of the first battery cells 10-M. In this case, it is difficult to make a difference in the amount of charged power between the plurality of second battery cells 11-N included in the second battery cell group sufficiently small. Accordingly, after a difference in the amount of charged power between the plurality of second battery cells 11-N included in the second battery cell group is made to be small to a certain extent through corresponding processing, it is possible to make the difference even smaller by using the first processing example (minute adjustment). In addition, the fourth or fifth processing example may be employed instead of the first processing example. That is, it is possible to make a difference in the amount of charged power between the plurality of second battery cells 11-N included in the second battery cell group even smaller by supplying power from one of the first battery cells 10-M to one of the second battery cells 11-N (minute adjustment).

When the balance processing S12 is completed, the cell monitor and balance controller 17 makes an input indicating the completion to the charging and discharging controller 18. In this case, charging of the electricity storage unit 10 is initiated by control of the charging and discharging controller 18 (S13). The cell monitor and balance controller 17 monitors the amount of charged power of each of the plurality of first battery cells 10-M during the charging process. In addition, when sensing that the amount of charged power reaches a target amount of power (for example, a state in which at least one of the first battery cells 10-M reaches a predetermined SOC level, a state in which all of the first battery cells 10-M reach the predetermined SOC level, or the like) (S14), the cell monitor and balance controller 17 makes an input indicating this state to the charging and discharging controller 18. In this case, the charging and discharging controller 18 stops charging of the electricity storage unit 10. Then, the cell monitor and balance controller 17 performs balance processing with respect to the electricity storage unit 10 (S15). The balance processing can be realized by one of the following sixth and seventh processing examples, or in combination thereof.

As a sixth processing example, the cell monitor and balance controller 17 can make a difference in the amount of charged power between the plurality of first battery cells 10-M included in the first battery cell group small by equally supplying power from all of the second battery cells 11-N included in the second battery cell group to the first battery cell 10-M in which the amount of charged power is less than that in the remaining first battery cells 10-M among the plurality of first battery cells 10-M included in the first battery cell group. In addition, since the power is equally supplied from all of the second battery cells 11-N included in the second battery cell group, the balance between the plurality of second battery cells 11-N included in the second battery cell group does not deteriorate.

As a seventh processing example, the cell monitor and balance controller 17 can make a difference in the amount of charged power between the plurality of first battery cells 10-M included in the first battery cell group small by equally supplying power from the first battery cell 10-M in which the amount of charged power is greater than that in the remaining first battery cells 10-M among the plurality of first battery cells 10-M included in the first battery cell group to all of the second battery cells 11-N included in the second battery cell group. In addition, since power is equally supplied to all of the second battery cells 11-N included in the second battery cell group, the balance between the plurality of second battery cells 11-N included in the second battery cell group does not deteriorate.

According to the balance processing, it is possible to make a difference in the amount of charged power between the plurality of first battery cells 10-M included in the first battery cell group small without discharging charged power.

In addition, according to the balance processing, power delivery is not performed between the first battery cells 10-M, and is performed from the first battery cells 10-M to the second battery cells 11-N or from the second battery cells 11-N to the first battery cells 10-M. In this manner, the balance processing is performed with respect to the first battery cell group by using the second battery cells 11-N which are capable of performing high-speed charging and discharging, and thus it is possible to make the speed of the balance processing fast with respect to the first battery cell group.

In addition, it is not necessary to perform the balance processing with respect to the first battery cell group only with the sixth and seventh processing examples, and a power delivery process between the first battery cells 10-M through the voltage adjustment unit 14 may be performed in combination. Even in this case, it is possible make a processing speed faster in comparison to a case of performing the balance processing only with the power delivery process between the first battery cell 10-M.

In addition, it is not necessary to perform the balance processing with respect to the first battery cell group only with the sixth and seventh processing examples, and balance processing (passive cell balance type) of discharging power may be performed in combination. Even in this manner, it is possible to further decrease an amount of discharge in comparison to a case of performing the balance processing with respect to the first battery cell group only with the passive cell balance type.

In addition, in the case of the sixth and seventh processing examples, a situation, in which a voltage on a power reception side becomes greater than a voltage on a power supply side, may occur. This embodiment solves the problem by using the voltage adjustment unit 14. Details thereof are the same as described above, and thus description thereof will not be repeated.

In addition, as balance processing in combination of the sixth and seventh processing examples, the following configuration may be considered. First, power is supplied from the electricity storage unit 10 to the auxiliary electricity storage unit 11 by using the sixth processing example so as to make a difference in the amount of charged power between the plurality of first battery cells 10-M included in the first battery cell group small. In addition, it is assumed that the voltage adjustment unit 14 does not include the DC/DC converter. According to this, power supply from the electricity storage unit 10 to the auxiliary electricity storage unit 11 is performed in a unit of a plurality of first battery cells 10-M which are connected in series (it is assumed that a voltage of one of the first battery cells 10-M is lower than a voltage of the second battery group in which the plurality of second battery cells 11-N are connected in series). That is, power supply is performed from two or three of the first battery cells 10-M which are connected in series to the second battery group in which the plurality of second battery cells 11-N are connected in series. In this case, it is difficult to make a difference in the amount of charged power between the plurality of first battery cells 10-M included in the first battery cell group sufficiently small. Accordingly, after a difference in the amount of charged power between the plurality of first battery cells 10-M included in the first battery cell group is made to be small to a certain extent through corresponding processing, it is possible to make the difference even smaller by using the seventh processing example (minute adjustment). That is, it is possible to make a difference in the amount of charged power between the plurality of first battery cells 10-M included in the first battery cell group even smaller by supplying power from the second battery group in which the plurality of second battery cells 11-N are connected in series to one of the first battery cells 10-M (minute adjustment). In addition, a passive cell balance type may be employed instead of the seventh processing example.

### Charging Example 2

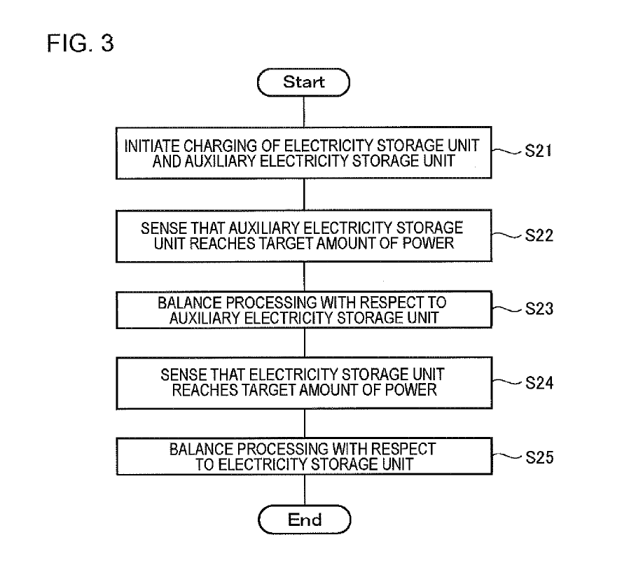

FIG. 3 is a flowchart illustrating an example of a process flow during charging. In Charging Example 1, charging of the auxiliary electricity storage unit 11 and charging of the electricity storage unit 10 are individually performed, but in Charging Example 2, charging of the auxiliary electricity storage unit 11 and charging of the electricity storage unit 10 are simultaneously performed.

When sensing connection of the external power supply 20, the storage battery initiates charging. In addition, before initiation of the charging, the cell monitor and balance controller 17 may detect an amount of charged power of the electricity storage unit 10, the auxiliary electricity storage unit 11, each of the first battery cells 10-M, and each of the second battery cells 11-N. In addition, in an over-discharged state or an over-charged state, the charging may be initiated after performing abnormality processing (minute charging or minute discharging). On the other hand, if it is not in the over-discharged state or the over-charged state, the charging may be initiated as is.

In the example, charging of the electricity storage unit 10 and charging of the auxiliary electricity storage unit 11 are simultaneously performed (S21). The charging is realized by control of the charging and discharging controller 18. The cell monitor and balance controller 17 monitors the amount of charged power of each of the plurality of first battery cells 10-M, and the amount of charged power of each of the plurality of second battery cells 11-N during the charging process. In addition, when sensing that the amount of charged power of the auxiliary electricity storage unit 11 reaches a target amount of power (for example, a state in which at least one of the second battery cells 11-N reaches a predetermined SOC level, a state in which all of the second battery cells 11-N reaches the predetermined SOC level, and the like) (S22), the cell monitor and balance controller 17 makes an input indicating this state to the charging and discharging controller 18. In this case, the charging and discharging controller 18 stops charging the auxiliary electricity storage unit 11 and the electricity storage unit 10. Then, the cell monitor and balance controller 17 performs balance processing with respect to the auxiliary electricity storage unit 11 (S23). In addition, the auxiliary electricity storage unit 11 reaches the target amount of power prior to the electricity storage unit 10 due to a difference in capacity and charging speed.

Details of balance processing with respect to the auxiliary electricity storage unit 11 are the same as in Charging Example 1. When the balance processing with respect to the auxiliary electricity storage unit 11 is completed, the cell monitor and balance controller 17 makes an input indicating the completion to the charging and discharging controller 18. In this case, charging of the electricity storage unit 10 is restarted by the control of the charging and discharging controller 18. The cell monitor and balance controller 17 monitors the amount of charged power of each of the plurality of first battery cells 10-M during the charging process. In addition, when sensing that the amount of charged power of the electricity storage unit 10 reaches a target amount of power (for example, a state in which at least one of the first battery cells 10-M reaches a predetermined SOC level, a state in which all of the first battery cells 10-M reaches the predetermined SOC level, and the like) (S24), the cell monitor and balance controller 17 makes an input indicating this state to the charging and discharging controller 18. In this case, the charging and discharging controller 18 stops charging of the electricity storage unit 10. Then, the cell monitor and balance controller 17 performs the balance processing with respect to the electricity storage unit 10 (S25). Details of the balance processing with respect to the electricity storage unit 10 are the same as in Charging Example 1.

In addition, in the above-described example, during the balance processing with respect to the auxiliary electricity storage unit 11, charging from the external power supply to the electricity storage unit 10 is stopped. However, for example, in the case that the balance processing with respect to the auxiliary electricity storage unit 11 is performed using the first processing example, the charging from the external power supply to the electricity storage unit 10 continues even during the balance processing with respect to the auxiliary electricity storage unit 11.

### Discharging Example 1

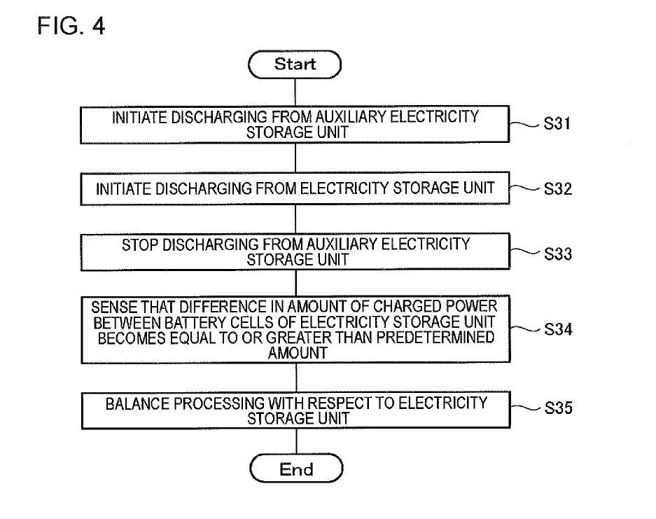

FIG. 4 is a flowchart illustrating an example of a process flow during discharging.

When the load (for example, a motor) 21 is connected to the storage battery, and an input for driving the load 21 is made, the storage battery initiates discharging. In addition, before initiation of the discharging, the cell monitor and balance controller 17 may detect an amount of charged power of the electricity storage unit 10, the auxiliary electricity storage unit 11, each of the first battery cells 10-M, and each of the second battery cells 11-N. In addition, in an over-discharged state or an over-charged state, the discharging may be initiated after performing abnormality processing (minute charging or minute discharging). In addition, in a case where the charging balance of the electricity storage unit 10 and/or the auxiliary electricity storage unit 11 deteriorates from a predetermined state due to any abnormality such as significant self-discharging (for example, a case where a difference in an amount of charged power, which is equal to or greater than a predetermined amount (designed value), is present between a plurality of battery cells, and the like), before initiation of the discharging, the cell monitor and balance controller 17 may perform balance processing by using any one of the first to seventh processing examples, balance processing (active cell balance type) between the same battery cells by using the capacitor 15 (or an inductor or a transformer) which are provided to the voltage adjustment unit 14, or balance processing (passive cell balance type) by using a discharging resistor (not illustrated). Then, the discharging may be initiated. On the other hand, in a case where it is not in the over-charged state or the over-discharged state, and abnormality is also not present, the discharging may be initiated as is.

First, discharging is initiated from the auxiliary electricity storage unit 11 in which charging and discharging are fast (S31). During discharging from the auxiliary electricity storage unit 11, the cell monitor and balance controller 17 monitors the amount of charged power of each of the plurality of second battery cells 11-N. In addition, at a low temperature, a process of warming the electricity storage unit 10 by using power, which is charged in the auxiliary electricity storage unit 11, may be performed before the discharging. Then, when discharging from the electricity storage unit 10 is initiated (S32), discharging from the auxiliary electricity storage unit 11 is stopped (S33). In addition, a predetermined amount (a predetermined SOC level) of power which is charged in the auxiliary electricity storage unit 11 may be left without being completely used. This process is realized by the cell monitor and balance controller 17 and the charging and discharging controller 18.

Then, discharging from the electricity storage unit 10 continues. In addition, discharging from the auxiliary electricity storage unit 11 is not performed. During this period, the cell monitor and balance controller 17 monitors the amount of charged power of each of the plurality of first battery cells 10-M. In addition, when sensing that a difference in an amount of charged power which is equal to or greater than a predetermined amount (designed value, for example: 50 mV) occurs between the plurality of first battery cells 10-M included in the first battery cell group (S34), the cell monitor and balance controller 17 initiates balance processing with respect to the electricity storage unit 10 (S35). The balance processing can be realized by one of the following eighth to twelfth processing examples, or in combination of two or more thereof.

As the eighth processing example, the cell monitor and balance controller 17 can make a difference in the amount of charged power between the plurality of first battery cells 10-M included in the first battery cell group small by supplying power from the first battery cell 10-M, in which the amount of charged power is greater than that in the remaining first battery cells 10-M among the plurality of first battery cells 10-M included in the first battery cell group, to the second battery cells 11-N.

As the ninth processing example, the cell monitor and balance controller 17 can make a difference in the amount of charged power between the plurality of first battery cells 10-M included in the first battery cell group small by supplying power from the first battery cell 10-M, in which the amount of charged power is greater than that in the remaining first battery cells 10-M among the plurality of first battery cells 10-M included in the first battery cell group, to the second battery cell 11-N in which the amount of charged power is less than that in the remaining second battery cells 11-N among the plurality of second battery cells 11-N included in the second battery cell group. In this case, it is also possible to make a difference in the amount of charged power between the plurality of second battery cells 11-N included in the second battery cell group small to a certain extent.

As the tenth processing example, the cell monitor and balance controller 17 can make a difference in the amount of charged power between the plurality of first battery cells 10-M included in the first battery cell group small by supplying power from the second battery cells 11-N to the first battery cell 10-M in which the amount of charged power is less than that in the remaining first battery cells 10-M among the plurality of first battery cells 10-M included in the first battery cell group.

As the eleventh processing example, the cell monitor and balance controller 17 can make a difference in the amount of charged power between the plurality of first battery cells 10-M included in the first battery cell group small by supplying power from the second battery cell 11-N, in which the amount of charged power is greater than that in the remaining second battery cells 11-N among the plurality of second battery cells 11-N included in the second battery cell group, to the first battery cell 10-M in which the amount of charged power is less than that in the remaining first battery cells 10-M among the plurality of first battery cells 10-M included in the first battery cell group. In this case, it is also possible to make a difference in the amount of charged power between the plurality of second battery cells 11-N included in the second battery cell group small to a certain extent.

As the twelfth processing example, the cell monitor and balance controller 17 connects only the first battery cell 10-M, in which the amount of charged power is less than that in the remaining first battery cells 10-M among the plurality of first battery cells 10-M included in the first battery cell group, to the second battery cell group in parallel, and then performs discharging while maintaining the connection state. According to this processing example, during the subsequent discharging, an amount of discharge from the first battery cell 10-M, in which the amount of charged power is less than that in the remaining first battery cells 10-M, becomes less than an amount of discharged power from the remaining first battery cells 10-M. As a result, as the discharging progresses, a difference in the amount of charged power between the plurality of first battery cells 10-M included in the first battery cell group decreases.

In addition, in the case of the eighth to eleventh processing examples, a situation, in which a voltage on a power reception side becomes greater than a voltage on a power supply side, may occur. This embodiment solves the problem by using the voltage adjustment unit 14. Details thereof are the same as described above, and thus description thereof will not be repeated.

When an input of stopping the driving of the load 21 is made, the discharging from the storage battery is terminated. When the discharging is terminated, the cell monitor and balance controller 17 can perform balance processing with respect to the auxiliary electricity storage unit 11 and the electricity storage unit 10 by using any one of the first to eleventh processing examples. In addition, the balance processing with respect to the auxiliary electricity storage unit 11 may not be performed at this stage.

Even after the discharging is terminated, self-discharging from the plurality of first battery cells 10-M and the plurality of second battery cells 11-N occurs. Accordingly, even when the discharging (discharging excepting the self-discharging) and the charging are not performed, the cell monitor and balance controller 17 may detect an amount of charged power of the electricity storage unit 10, the auxiliary electricity storage unit 11, each of the first battery cells 10-M, and each of the second battery cells 11-N at a predetermined timing. In addition, when sensing that a difference in an amount of charged power which is equal to or greater than a predetermined amount (designed value) occurs between the plurality of first battery cells 10-M included in the first battery cell group, and/or when sensing that a difference in an amount of charged power which is equal to or greater than a predetermined amount (designed value) occurs between the plurality of second battery cells 11-N included in the second battery cell group, the cell monitor and balance controller 17 may perform balance processing with respect to the auxiliary electricity storage unit 11 and the electricity storage unit 10 by using any one of the first to eleventh processing examples. In addition, the balance processing with respect to the auxiliary electricity storage unit 11 may not be performed at this stage.

### Discharging Example 2

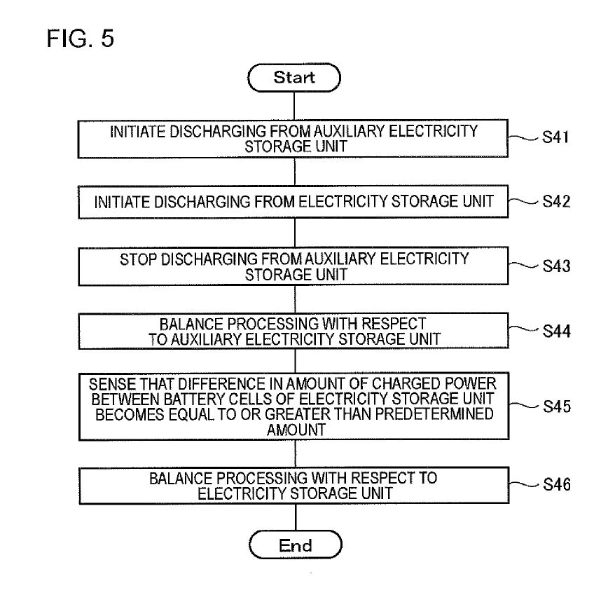

FIG. 5 is a flowchart illustrating an example of a process flow during discharging.

When the load (for example, a motor) 21 is connected to the storage battery, and an input for driving the load 21 is made, the storage battery initiates discharging. In addition, before initiation of the discharging, the cell monitor and balance controller 17 may detect an amount of charged power in the electricity storage unit 10, the auxiliary electricity storage unit 11, each of the first battery cells 10-M, and each of the second battery cells 11-N. In addition, in an over-discharged state or an over-charged state, the discharging may be initiated after performing abnormality processing (minute charging or minute discharging). In addition, in a case where the charging balance of the electricity storage unit 10 and/or the auxiliary electricity storage unit 11 deteriorates from a predetermined state due to any abnormality such as significant self-discharging (for example, a case where a difference in an amount of charged power, which is equal to or greater than a predetermined amount (designed value), is present between a plurality of battery cells, and the like), before initiation of the discharging, the cell monitor and balance controller 17 may perform balance processing by using any one of the first to seventh processing examples, balance processing (active cell balance type) between the same battery cells by using the capacitor 15 (or an inductor or a transformer) which are provided to the voltage adjustment unit 14, or balance processing (passive cell balance type) by using a discharging resistor (not illustrated). Then, the discharging may be initiated. On the other hand, in a case where it is not in the over-charged state or the over-discharged state, and abnormality is also not present, the discharging may be initiated as is.

First, discharging is initiated from the auxiliary electricity storage unit 11 in which charging and discharging are fast (S41). During discharging from the auxiliary electricity storage unit 11, the cell monitor and balance controller 17 monitors the amount of charged power of each of the plurality of second battery cells 11-N. In addition, at a low temperature, a process of warming the electricity storage unit 10 by using power, which is charged in the auxiliary electricity storage unit 11, may be performed before the discharging. Then, when discharging from the electricity storage unit 10 is initiated (S42), discharging from the auxiliary electricity storage unit 11 is stopped (S43). In addition, a predetermined amount (a predetermined SOC level) of power which is charged in the auxiliary electricity storage unit 11 may be left without being completely used. This process is realized by the cell monitor and balance controller 17 and the charging and discharging controller 18. Then, the cell monitor and balance controller 17 performs balance processing with respect to the auxiliary electricity storage unit 11 by using any one of the first to fifth processing examples (S44).

Then, the discharging from the electricity storage unit 10 continues. In addition, discharging from the auxiliary electricity storage unit 11 is not performed. During this period, the cell monitor and balance controller 17 monitors the amount of charged power of each of the plurality of first battery cells 10-M. In addition, when sensing that a difference in an amount of charged power which is equal to or greater than a predetermined amount (designed value, for example: 50 mV) occurs between the plurality of first battery cells 10-M included in the first battery cell group (S45), the cell monitor and balance controller 17 initiates balance processing with respect to the electricity storage unit 10 (S46). The cell monitor and balance controller 17 can perform the balance processing in S46 by using any one of the sixth and seventh processing examples. In addition, the cell monitor and balance controller 17 may perform the balance processing in S46 by using any one of the eighth to twelfth processing examples.

When an input for stopping the driving of the load 21 is made, the discharging from the storage battery is terminated. When the discharging is terminated, the cell monitor and balance controller 17 can perform balance processing with respect to the auxiliary electricity storage unit 11 and the electricity storage unit 10 by using any one of the first to eleventh processing examples. In addition, the balance processing with respect to the auxiliary electricity storage unit 11 may not be performed at this stage.

Even after the discharging is terminated, self-discharging from the plurality of first battery cells 10-M and the plurality of second battery cells 11-N occurs.

Accordingly, even when the discharging (discharging excepting the self-discharging) and the charging are not performed, the cell monitor and balance controller 17 may detect an amount of charged power in the electricity storage unit 10, the auxiliary electricity storage unit 11, each of the first battery cells 10-M, and each of the second battery cells 11-N at a predetermined timing. In addition, when sensing that a difference in an amount of charged power which is equal to or greater than a predetermined amount (designed value) occurs between the plurality of first battery cells 10-M included in the first battery cell group, and/or when sensing that a difference in an amount of charged power which is equal to or greater than a predetermined amount (designed value) occurs between the plurality of second battery cells 11-N included in the second battery cell group, the cell monitor and balance controller 17 may perform balance processing with respect to the auxiliary electricity storage unit 11 and the electricity storage unit 10 by using any one of the first to eleventh processing examples. In addition, the balance processing with respect to the auxiliary electricity storage unit 11 may not be performed at this stage.

As described above, in the storage battery and the operation method of the storage battery according to this embodiment, the balance processing with respect to the electricity storage unit 10 and the auxiliary electricity storage unit 11 can be performed by performing the power delivery between the electricity storage unit 10 and the auxiliary electricity storage unit 11. That is, the balance processing with respect to both the electricity storage unit 10 and the auxiliary electricity storage unit 11 is performed by one circuit (balance circuit) that performs the power delivery between the electricity storage unit 10 and the auxiliary electricity storage unit 11. According to this, it is not necessary to provide a balance circuit for both the electricity storage unit 10 and the auxiliary electricity storage unit 11. As a result, in addition to a reduction in an installation space for the balance circuit, it is possible to further reduce the cost in comparison to the case of providing the balance circuit for both the electricity storage unit 10 and the auxiliary electricity storage unit 11. In addition, in a case where a capacity difference as large as that between the electricity storage unit 10 and the auxiliary electricity storage unit 11 is present, even when the balance circuit is commonly used between the electricity storage unit 10 and the auxiliary electricity storage unit 11, a balance time is not significantly lengthened.

In addition, in this embodiment, it is possible to further reduce an amount of useless discharge than when performing the balance processing with respect to the electricity storage unit 10 and the auxiliary electricity storage unit 11 by using only the passive cell balance type.

In addition, in this embodiment, the balance processing with respect to the electricity storage unit 10 is realized by performing power delivery between the first battery cells 10-M and the second battery cells 11-N capable of performing high-speed charging and discharging instead of power delivery between the first battery cells 10-M which are not capable of performing the high-speed charging and discharging. Accordingly, it is possible to raise processing speed.

<Additional Statement>

Hereinafter, examples of reference aspects will be additionally stated.

1. A storage battery, including:

an electricity storage unit including a first battery cell group in which a plurality of first battery cells are connected in series;

an auxiliary electricity storage unit which includes a second battery cell group in which a plurality of second battery cells capable of performing higher-speed charging and discharging in comparison to the first battery cells are connected in series, and performs power delivery with the electricity storage unit;

a voltage adjustment unit that performs voltage adjustment during the power delivery between the electricity storage unit and the auxiliary electricity storage unit;

a first switching unit which is capable of individually connecting the plurality of first battery cells included in the first battery cell group to the voltage adjustment unit, and which is capable of connecting the first battery cells to the voltage adjustment unit in an individual combination unit of two or more of the first battery cells which are adjacent to each other; and

a second switching unit which is capable of individually connecting the plurality of second battery cells included in the second battery cell group to the voltage adjustment unit, and which is capable of connecting the second battery cells to the voltage adjustment unit in an individual combination unit of two or more of the second battery cells which are adjacent to each other.

2. The storage battery according to 1, further including:

a balance processing unit which performs a process of supplying power from one or the plurality of first battery cells to one or the plurality of second battery cells through the voltage adjustment unit, and a process of supplying power from one or the plurality of second battery cells to one or the plurality of first battery cells through the voltage adjustment unit.

3. The storage battery according to 2,

wherein the balance processing unit makes a difference in an amount of charged power between the plurality of second battery cells included in the second battery cell group smaller than a predetermined amount, and then equally supplies power from all of the second battery cells included in the second battery cell group to the first battery cell in which an amount of charged power is less than an amount of charged power in the remaining first battery cells among the plurality of first battery cells included in the first battery cell group so as to make the difference in the amount of charged power between the plurality of first battery cells included in the first battery cell group small.

4. The storage battery according to 2,

wherein the balance processing unit makes a difference in an amount of charged power between the plurality of second battery cells included in the second battery cell group smaller than a predetermined amount, and then equally supplies power from the first battery cell, in which an amount of charged power is greater than an amount of charged power in the remaining first battery cells among the plurality of first battery cells included in the first battery cell group, to all of the second battery cells included in the second battery cell group so as to make the difference in the amount of charged power between the plurality of first battery cells included in the first battery cell group small.

5. The storage battery according to any one of 2 to 4,

wherein the balance processing unit supplies power from the second battery cell, in which the amount of charged power is greater than the amount of charged power in the remaining second battery cells among the plurality of second battery cells included in the second battery cell group, to the first battery cells so as to make a difference in the amount of charged power between the plurality of second battery cells included in the second battery cell group small.

6. The storage battery according to 5,

wherein the balance processing unit supplies power from the second battery cell, in which the amount of charged power is greater than the amount of charged power in the remaining second battery cells among the plurality of second battery cells included in the second battery cell group, to the first battery cell in which the amount of charged power is less than the amount of charged power in the remaining first battery cells among the plurality of first battery cells included in the first battery cell group so as to make a difference in the amount of charged power between the plurality of second battery cells included in the second battery cell group small, and so as to make a difference in the amount of charged power between the plurality of first battery cells included in the first battery cell group small.

7. The storage battery according to any one of 2 to 4,

wherein the balance processing unit supplies power from the first battery cells to the second battery cell in which the amount of charged power is less than the amount of charged power in the remaining second battery cells among the plurality of second battery cells included in the second battery cell group so as to make a difference in the amount of charged power between the plurality of second battery cells included in the second battery cell group small.

8. The storage battery according to 7,

wherein the balance processing unit supplies power from the first battery cell, in which the amount of charged power is greater than the amount of charged power in the remaining first battery cells among the plurality of first battery cells included in the first battery cell group, to the second battery cell in which the amount of charged power is less than the amount of charged power in the remaining second battery cells among the plurality of second battery cells included in the second battery cell group so as to make a difference in the amount of charged power between the plurality of second battery cells included in the second battery cell group small, and so as to make a difference in the amount of charged power between the plurality of first battery cells included in the first battery cell group small.

9. The storage battery according to any one of 2 to 8,

wherein the voltage adjustment unit includes a capacitor, an inductor, or a transformer, and

the balance processing unit is capable of executing a process of making a difference in the amount of charged power between the second battery cells small by performing power delivery between the plurality of second battery cells included in the second battery cell group by using the capacitor, the inductor, or the transformer.

10. The storage battery according to any one of 2 to 9,

wherein when a difference in the amount of charged power, which is equal to or greater than a predetermined amount, occurs between the plurality of first battery cells included in the first battery cell group due to power discharging, the balance processing unit supplies power from the first battery cell, in which the amount of charged power is greater than the amount of charged power in the remaining first battery cells among the plurality of first battery cells included in the first battery cell group, to the second battery cells so as to make a difference in the amount of charged power between the plurality of first battery cells included in the first battery cell group small.

11. The storage battery according to 10,

wherein when a difference in the amount of charged power, which is equal to or greater than a predetermined amount, occurs between the plurality of first battery cells included in the first battery cell group due to power discharging, the balance processing unit supplies power from the first battery cell, in which the amount of charged power is greater than the amount of charged power in the remaining first battery cells among the plurality of first battery cells included in the first battery cell group, to the second battery cell in which the amount of charged power is less than the amount of charged power in the remaining second battery cells among the plurality of second battery cells included in the second battery cell group so as to make a difference in the amount of charged power between the plurality of first battery cells included in the first battery cell group small, and so as to make a difference in the amount of charged power between the plurality of second battery cells included in the second battery cell group small.

12. The storage battery according to any one of 2 to 9,
wherein when a difference in the amount of charged power, which is equal to or greater than a predetermined amount, occurs between the plurality of first batter cells included in the first battery cell group due to power discharging, the balance processing unit supplies power from the second battery cells to the first battery cell in which the amount of charged power is less than the amount of charged power in the remaining first battery cells among the plurality of first battery cells included in the first battery cell group so as to make a difference in the amount of charged power between the plurality of first battery cells included in the first battery cell group small.

13. The storage battery according to 12,
wherein when a difference in the amount of charged power, which is equal to or greater than a predetermined amount, occurs between the plurality of first battery cells included in the first battery cell group due to power discharging, the balance processing unit supplies power from the second battery cell, in which the amount of charged power is greater than the amount of charged power in the remaining second battery cells among the plurality of second battery cells included in the second battery cell group, to the first battery cell in which the amount of charged power is less than the amount of charged power in the remaining first battery cells among the plurality of first battery cells included in the first battery cell group so as to make a difference in the amount of charged power between the plurality of first battery cells included in the first battery cell group small, and so as to make a difference in the amount of charged power between the plurality of second battery cells included in the second battery cell group small.

14. The storage battery according to any one of 2 to 9,
wherein when a difference in the amount of charged power, which is equal to or greater than a predetermined amount, occurs between the plurality of first battery cells included in the first battery cell group due to power discharging, during the subsequent discharging, the balance processing unit connects only the first battery cell, in which the amount of charged power is less than the amount of charged power in the remaining first battery cells among the plurality of first battery cells included in the first battery cell group, to the second battery cell group in parallel.

15. An operation method of a storage battery,
wherein storage battery includes,
an electricity storage unit including a first battery cell group in which a plurality of first battery cells are connected in series,
an auxiliary electricity storage unit which includes a second battery cell group in which a plurality of second battery cells capable of performing higher-speed charging and discharging in comparison to the first battery cells are connected in series,
a voltage adjustment unit,
a first switching unit which is capable of individually connecting the plurality of first battery cells included in the first battery cell group to the voltage adjustment unit, and which is capable of connecting the first battery cells to the voltage adjustment unit in an individual combination unit of two or more of the first battery cells which are adjacent to each other, and
a second switching unit which is capable of individually connecting the plurality of second battery cells included in the second battery cell group to the voltage adjustment unit, and which is capable of connecting the second battery cells to the voltage adjustment unit in an individual combination unit of two or more of the second battery cells which are adjacent to each other, and
a difference in an amount of charged power between the plurality of first battery cells included in the first battery cell group is made to be small, and a difference in an amount of charged power between the plurality of second battery cells included in the second battery cell group is made to be small through a process of supplying power from one or the plurality of first battery cells to one or the plurality of second battery cells through the voltage adjustment unit, and a process of supplying power from one or the plurality of second battery cells to one or the plurality of first battery cells through the voltage adjustment unit.

15-2. The operation method of a storage battery according to 15,
wherein a difference in an amount of charged power between the plurality of second battery cells included in the second battery cell group is made to be smaller than a predetermined amount, and then power is equally supplied from all of the second battery cells included in the second battery cell group to the first battery cell in which an amount of charged power is less than an amount of charged power in the remaining first battery cells among the plurality of first battery cells included in the first battery cell group so as to make the difference in the amount of charged power between the plurality of first battery cells included in the first battery cell group small.

15-3. The operation method of a storage battery according to 15,

wherein a difference in an amount of charged power between the plurality of second battery cells included in the second battery cell group is made to be smaller than a predetermined amount, and then power is equally supplied from the first battery cell, in which an amount of charged power is greater than an amount of charged power in the remaining first battery cells among the plurality of first battery cells included in the first battery cell group, to all of the second battery cells included in the second battery cell group so as to make the difference in the amount of charged power between the plurality of first battery cells included in the first battery cell group small.

15-4. The operation method of a storage battery according to any one of 15 to 15-3,
wherein power is supplied from the second battery cell, in which the amount of charged power is greater than the amount of charged power in the remaining second battery cells among the plurality of second battery cells included in the second battery cell group, to the first battery cells so as to make a difference in the amount of charged power between the plurality of second battery cells included in the second battery cell group small.

15-5. The operation method of a storage battery according to 15-4,
wherein power is supplied from the second battery cell, in which the amount of charged power is greater than the amount of charged power in the remaining second battery cells among the plurality of second battery cells included in the second battery cell group, to the first battery cell in which the amount of charged power is less than the amount of charged power in the remaining first battery cells among the plurality of first battery cells included in the first battery cell group so as to make a difference in the amount of charged power between the plurality of second battery cells included in the second battery cell group small, and so as to make a difference in the amount of charged power between the plurality of first battery cells included in the first battery cell group small.

15-6. The operation method of a storage battery according to any one of 15 to 15-3,

wherein power is supplied from the first battery cells to the second battery cell in which the amount of charged power is less than the amount of charged power in the remaining second battery cells among the plurality of second battery cells included in the second battery cell group so as to make a difference in the amount of charged power between the plurality of second battery cells included in the second battery cell group small.

15-7. The operation method of a storage battery according to 15-6,

wherein power is supplied from the first battery cell, in which the amount of charged power is greater than the amount of charged power in the remaining first battery cells among the plurality of first battery cells included in the first battery cell group, to the second battery cell in which the amount of charged power is less than the amount of charged power in the remaining second battery cells among the plurality of second battery cells included in the second battery cell group so as to make a difference in the amount of charged power between the plurality of second battery cells included in the second battery cell group small, and so as to make a difference in the amount of charged power between the plurality of first battery cells included in the first battery cell group small.

15-8. The operation method of a storage battery according to any one of 15 to 15-7,

wherein the voltage adjustment unit includes a capacitor, an inductor, or a transformer, and

a process of making a difference in the amount of charged power between the second battery cells small is capable of being executed by performing power delivery between the plurality of second battery cells included in the second battery cell group by using the capacitor, the inductor, or the transformer.

15-9. The operation method of a storage battery according to any one of 15 to 15-8,

wherein when a difference in the amount of charged power, which is equal to or greater than a predetermined amount, occurs between the plurality of first battery cells included in the first battery cell group due to power discharging, power is supplied from the first battery cell, in which the amount of charged power is greater than the amount of charged power in the remaining first battery cells among the plurality of first battery cells included in the first battery cell group, to the second battery cells so as to make a difference in the amount of charged power between the plurality of first battery cells included in the first battery cell group small.

15-10. The operation method of a storage battery according to 15-9,

wherein when a difference in the amount of charged power, which is equal to or greater than a predetermined amount, occurs between the plurality of first battery cells included in the first battery cell group due to power discharging, power is supplied from the first battery cell, in which the amount of charged power is greater than the amount of charged power in the remaining first battery cells among the plurality of first battery cells included in the first battery cell group, to the second battery cell in which the amount of charged power is less than the amount of charged power in the remaining second battery cells among the plurality of second battery cells included in the second battery cell group so as to make a difference in the amount of charged power between the plurality of first battery cells included in the first battery cell group small, and so as to make a difference in the amount of charged power between the plurality of second battery cells included in the second battery cell group small.

15-11. The operation method of a storage battery according to any one of 15 to 15-8,

wherein when a difference in the amount of charged power, which is equal to or greater than a predetermined amount, occurs between the plurality of first battery cells included in the first battery cell group due to power discharging, power is supplied from the second battery cells to the first battery cell in which the amount of charged power is less than the amount of charged power in the remaining first battery cells among the plurality of first battery cells included in the first battery cell group so as to make a difference in the amount of charged power between the plurality of first battery cells included in the first battery cell group small.

15-12. The operation method of a storage battery according to 15-11,

wherein when a difference in the amount of charged power, which is equal to or greater than a predetermined amount, occurs between the plurality of first battery cells included in the first battery cell group due to power discharging, power is supplied from the second battery cell, in which the amount of charged power is greater than the amount of charged power in the remaining second battery cells among the plurality of second battery cells included in the second battery cell group, to the first battery cell in which the amount of charged power is less than the amount of charged power in the remaining first battery cells among the plurality of first battery cells included in the first battery cell group so as to make a difference in the amount of charged power between the plurality of first battery cells included in the first battery cell group small, and so as to make a difference in the amount of charged power between the plurality of second battery cells included in the second battery cell group small.

15-13. The operation method of a storage battery according to any one of 15 to 15-8,

wherein when a difference in the amount of charged power, which is equal to or greater than a predetermined amount, occurs between the plurality of first battery cells included in the first battery cell group due to power discharging, during the subsequent discharging, only the first battery cell, in which the amount of charged power is less than the amount of charged power in the remaining first battery cells among the plurality of first battery cells included in the first battery cell group, is connected to the second battery cell group in parallel.

Priority is claimed on Japanese Patent Application No. 2013-069161, filed Mar. 28, 2013, the content of which is incorporated herein by reference.

1. A storage battery, comprising:
an electricity storage unit including a first electricity storage unit group in which a plurality of first electricity storage units are connected in series;
an auxiliary electricity storage unit which includes a second electricity storage unit group in which a plurality of second electricity storage units capable of performing higher-speed charging and discharging in comparison to the first electricity storage units are connected in series, and performs power delivery with the electricity storage unit;
a voltage adjustment unit that performs voltage adjustment during the power delivery between the electricity storage unit and the auxiliary electricity storage unit;
a first switching unit which is capable of individually connecting the plurality of first electricity storage units included in the first electricity storage unit group to the voltage adjustment unit, and which is capable of connecting the first electricity storage units to the voltage adjustment unit in an individual combination unit of two or more of the first electricity storage units; and
a second switching unit which is capable of individually connecting the plurality of second electricity storage units included in the second electricity storage unit group to the voltage adjustment unit, and which is capable of connecting the second electricity storage units to the voltage adjustment unit in an individual combination unit of two or more of the second electricity storage units.

2. The storage battery according to claim 1, further comprising:
a balance processing unit which performs a process of supplying power from one or the plurality of first electricity storage units to one or the plurality of second electricity storage units through the voltage adjustment unit, and a process of supplying power from one or the plurality of second electricity storage units to one or the plurality of first electricity storage units through the voltage adjustment unit.

3. The storage battery according to claim 2,
wherein the balance processing unit makes a difference in an amount of charged power between the plurality of second electricity storage units included in the second electricity storage unit group smaller than a predetermined amount, and then equally supplies power from all of the second electricity storage units included in the second electricity storage unit group to the first electricity storage unit in which an amount of charged power is less than an amount of charged power in the remaining first electricity storage units among the plurality of first electricity storage units included in the first electricity storage unit group so as to make the difference in the amount of charged power between the plurality of first electricity storage units included in the first electricity storage unit group small.

4. The storage battery according to claim 2,
wherein the balance processing unit makes a difference in an amount of charged power between the plurality of second electricity storage units included in the second electricity storage unit group smaller than a predetermined amount, and then equally supplies power from the first electricity storage unit, in which an amount of charged power is greater than an amount of charged power in the remaining first electricity storage units among the plurality of first electricity storage units included in the first electricity storage unit group, to all of the second electricity storage units included in the second electricity storage unit group so as to make the difference in the amount of charged power between the plurality of first electricity storage units included in the first electricity storage unit group small.

5. The storage battery according to claim 2,
wherein the balance processing unit supplies power from the second electricity storage unit, in which the amount of charged power is greater than the amount of charged power in the remaining second electricity storage units among the plurality of second electricity storage units included in the second electricity storage unit group, to the first electricity storage units so as to make a difference in the amount of charged power between the plurality of second electricity storage units included in the second electricity storage unit group small.

6. The storage battery according to claim 5,
wherein the balance processing unit supplies power from the second electricity storage unit, in which the amount of charged power is greater than the amount of charged power in the remaining second electricity storage units among the plurality of second electricity storage units included in the second electricity storage unit group, to the first electricity storage unit in which the amount of charged power is less than the amount of charged power in the remaining first electricity storage units among the plurality of first electricity storage units included in the first electricity storage unit group so as to make a difference in the amount of charged power between the plurality of second electricity storage units included in the second electricity storage unit group small, and so as to make a difference in the amount of charged power between the plurality of first electricity storage units included in the first electricity storage unit group small.

7. The storage battery according to claim 2,
wherein the balance processing unit supplies power from the first electricity storage units to the second electricity storage unit in which the amount of charged power is less than the amount of charged power in the remaining second electricity storage units among the plurality of second electricity storage units included in the second electricity storage unit group so as to make a difference in the amount of charged power between the plurality of second electricity storage units included in the second electricity storage unit group small.

8. The storage battery according to claim 7,
wherein the balance processing unit supplies power from the first electricity storage unit, in which the amount of charged power is greater than the amount of charged power in the remaining first electricity storage units among the plurality of first electricity storage units included in the first electricity storage unit group, to the second electricity storage unit in which the amount of charged power is less than the amount of charged power in the remaining second electricity storage units among the plurality of second electricity storage units included in the second electricity storage unit group so as to make a difference in the amount of charged power between the plurality of second electricity storage units included in the second electricity storage unit group small, and so as to make a difference in the amount of charged power between the plurality of first electricity storage units included in the first electricity storage unit group small.

9. The storage battery according to claim 2,
wherein the voltage adjustment unit includes a capacitor, an inductor, or a transformer, and
the balance processing unit is capable of executing a process of making a difference in the amount of charged power between the second electricity storage units small by performing power delivery between the plurality of second electricity storage units included in the second electricity storage unit group by using the capacitor, the inductor, or the transformer.

10. The storage battery according to claim 2,
wherein when a difference in the amount of charged power, which is equal to or greater than a predetermined amount, occurs between the plurality of first electricity storage units included in the first electricity storage unit group due to power discharging, the balance processing unit supplies power from the first electricity storage unit, in which the amount of charged power is greater than the amount of charged power in the remaining first electricity storage units among the plurality of first electricity storage units included in the first electricity storage unit group, to the second electricity storage units so as to make a difference in the amount of charged power between the plurality of first electricity storage units included in the first electricity storage unit group small.

11. The storage battery according to claim 10,
wherein when a difference in the amount of charged power, which is equal to or greater than a predetermined amount, occurs between the plurality of first electricity storage units included in the first electricity storage unit group due to power discharging, the balance processing unit supplies power from the first electricity storage unit, in which the amount of charged power is greater than the amount of charged power in the remaining first electricity storage units among the plurality of first electricity storage units included in the first electricity storage unit group, to the second electricity storage unit in which the amount of charged power is less than the amount of charged power in the remaining second electricity storage units among the plurality of second electricity storage units included in the second electricity storage unit group so as to make a difference in the amount of charged power between the plurality of first electricity storage units included in the first electricity storage unit group small, and so as to make a difference in the amount of charged power between the plurality of second electricity storage units included in the second electricity storage unit group small.

12. The storage battery according to claim 2,
wherein when a difference in the amount of charged power, which is equal to or greater than a predetermined amount, occurs between the plurality of first electricity storage units included in the first electricity storage unit group due to power discharging, the balance processing unit supplies power from the second electricity storage units to the first electricity storage unit in which the amount of charged power is less than the amount of charged power in the remaining first electricity storage units among the plurality of first electricity storage units included in the first electricity storage unit group so as to make a difference in the amount of charged power between the plurality of first electricity storage units included in the first electricity storage unit group small.

13. The storage battery according to claim 12,
wherein when a difference in the amount of charged power, which is equal to or greater than a predetermined amount, occurs between the plurality of first electricity storage units included in the first electricity storage unit group due to power discharging, the balance processing unit supplies power from the second electricity storage unit, in which the amount of charged power is greater than the amount of charged power in the remaining second electricity storage units among the plurality of second electricity storage units included in the second electricity storage unit group, to the first electricity storage unit in which the amount of charged power is less than the amount of charged power in the remaining first electricity storage units among the plurality of first electricity storage units included in the first electricity storage unit group so as to make a difference in the amount of charged power between the plurality of first electricity storage units included in the first electricity storage unit group small, and so as to make a difference in the amount of charged power between the plurality of second electricity storage units included in the second electricity storage unit group small.

14. The storage battery according to claim 2,
wherein when a difference in the amount of charged power, which is equal to or greater than a predetermined amount, occurs between the plurality of first electricity storage units included in the first electricity storage unit group due to power discharging, during the subsequent discharging, the balance processing unit connects only the first electricity storage unit, in which the amount of charged power is less than the amount of charged power in the remaining first electricity storage units among the plurality of first electricity storage units included in the first electricity storage unit group, to the second electricity storage unit group in parallel.

15. An operation method of a storage battery,
wherein the storage battery includes,
an electricity storage unit including a first electricity storage unit group in which a plurality of first electricity storage units are connected in series,
an auxiliary electricity storage unit which includes a second electricity storage unit group in which a plurality of second electricity storage units capable of performing higher-speed charging and discharging in comparison to the first electricity storage units are connected in series,
a voltage adjustment unit,
a first switching unit which is capable of individually connecting the plurality of first electricity storage units included in the first electricity storage unit group to the voltage adjustment unit, and which is capable of connecting the first electricity storage units to the voltage adjustment unit in an individual combination unit of two or more of the first electricity storage units, and
a second switching unit which is capable of individually connecting the plurality of second electricity storage units included in the second electricity storage unit group to the voltage adjustment unit, and which is capable of connecting the second electricity storage units to the voltage adjustment unit in an individual combination unit of two or more of the second electricity storage units, and
a difference in an amount of charged power between the plurality of first electricity storage units included in the first electricity storage unit group is made to be small, and a difference in an amount of charged power between the plurality of second electricity storage units included in the second electricity storage unit group is made to be small through a process of supplying power from one or the plurality of first electricity storage units to one or the plurality of second electricity storage units through the voltage adjustment unit, and a process of supplying power from one or the plurality of second electricity storage units to one or the plurality of first electricity storage units through the voltage adjustment unit.

16. A storage battery, comprising:
an electricity storage means including a first electricity storage unit group in which a plurality of first electricity storage units are connected in series;
an auxiliary electricity storage means which includes a second electricity storage unit group in which a plurality of second electricity storage units capable of performing higher-speed charging and discharging in comparison to the first electricity storage units are connected in series, and performs power delivery with the electricity storage unit;
a voltage adjustment means that performs voltage adjustment during the power delivery between the electricity storage unit and the auxiliary electricity storage unit;
a first switching means which is capable of individually connecting the plurality of first electricity storage units included in the first electricity storage unit group to the voltage adjustment unit, and which is capable of connecting the first electricity storage units to the voltage adjustment unit in an individual combination unit of two or more of the first electricity storage units; and
a second switching means which is capable of individually connecting the plurality of second electricity storage units included in the second electricity storage unit group to the voltage adjustment unit, and which is capable of connecting the second electricity storage units to the voltage adjustment unit in an individual combination unit of two or more of the second electricity storage units.
